(19) United States
(12) Patent Application Publication
(10) Pub. No.: US 2024/0403632 A1
(43) Pub. Date: Dec. 5, 2024

(54) GENERATIVE ARTIFICIAL INTELLIGENCE BASED STATEFUL ADVICE SYSTEM HAVING DIRECT AND INDIRECT MODES OF OPERATIONS

(71) Applicant: INTUIT INC., Mountain View, CA (US)

(72) Inventors: Ronnie Douglas DOUTHIT, Trinidad, TX (US); Ramesh RAMAN, Pleasanton, CA (US)

(21) Appl. No.: 18/621,362

(22) Filed: Mar. 29, 2024

Related U.S. Application Data
(60) Provisional application No. 63/505,186, filed on May 31, 2023.

(51) Int. Cl. G06N 3/08; G06N 3/0475

(52) U.S. Cl. CPC G06N 3/08; G06N 3/0475

(57) ABSTRACT

A method for operating a stateful advice system includes determining, based on configuration data, whether a selected mode for the stateful advice system corresponds to a first mode in which a domain model is directly modified to implement one or more of a plurality of different strategies or a second mode in which the domain model is indirectly modified via a model schema of the domain model. The method includes providing a prompt to a generative artificial intelligence (AI) model configured to determine applicability of each of the plurality of different strategies to the domain model. The prompt includes the domain model when the selected mode corresponds to the first mode or the model schema when the selected mode corresponds to the second mode. The method includes receiving one or more recommendations from the generative AI model.

### RELATED APPLICATIONS

This application claims the benefit of U.S. Provisional Application No. 63/505,186, titled “GENERATIVE ARTIFICIAL INTELLIGENCE BASED STATEFUL ADVICE SYSTEM,” by the same inventors, filed 31 May 2023, the contents of which are incorporated herein in their entirety.

### BACKGROUND

Aspects of the present disclosure relate to stateful advice systems that use generative artificial intelligence (AI) models in order to provide stateful sequences of operations (e.g., text and/or computer-code) for implementing different strategies (e.g., advice).

### BACKGROUND

Stateful advice systems can provide a recommendation to a user and can perform a series of actions if the user accepts the recommendation. Stateful advice systems can also revert those actions if the user changes their mind. In some instances, stateful advice systems can provide multiple recommendations to the user. In such instances, stateful advice systems produce a unified state that represents all recommendations accepted by the user.

Stateful advice systems based on rules are difficult to scale because of the effort that is required to comprehend the problem and the solution domains and translate them into one or more computer languages. Generally speaking, a cross functional team (e.g., product managers, user experience designers, domain experts, software engineers) is needed to scale stateful advice system. Implementing such a team can be time-consuming and cost prohibitive.

Accordingly, there is a need in the art for systems and methods for scaling stateful advice systems that address the issues discussed above.

### BRIEF SUMMARY

Aspects and advantages of embodiments of the present disclosure will be set forth in part in the following description, or may be learned from the description, or may be learned through practice of the embodiments.

In one embodiment, a method for operating a stateful advice system is provided. The method includes: obtaining configuration data for the stateful advice system; determining, based on the configuration data, whether a selected mode for the stateful advice system corresponds to a first mode in which a domain model is directly modified to implement one or more of a plurality of different strategies or a second mode in which the domain model is indirectly modified via a model schema of the domain model to implement one or more of the plurality of different strategies; providing a prompt to a generative artificial intelligence model configured to determine applicability of each of the plurality of different strategies to the domain model, wherein the prompt includes the domain model when the selected mode corresponds to the first mode or the model schema when the selected mode corresponds to the second; and receiving one or more recommendations from the generative AI model, the one or more recommendations corresponding to one or more of the plurality of different strategies the generative AI model determined are applicable to the domain model.

Further embodiments include a non-transitory computer-readable storage medium storing instructions that, when executed by a computer system, cause the computer system to perform the method set forth above. Further embodiments include a system comprising at least one memory and at least one processor configured to perform the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example stateful advice system according to some embodiments of the present disclosure.

FIG. 2 depicts an advice design time architecture for a stateful advice system according to some embodiments of the present disclosure.

FIG. 3 depicts an advice runtime architecture for a stateful advice system according to some embodiments of the present disclosure.

FIG. 4 depicts a sequence diagram of advice design time and advice run time for a stateful advice system according to some embodiments of the present disclosure.

FIG. 5 depicts a flow diagram of a method for using a stateful advice system according to some embodiments of the present disclosure.

FIGS. 6A and 6B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure relate to stateful advice systems.

Stateful advice systems according to the present disclosure can include a generative AI model. The generative AI model can generate a majority (e.g., about 95 percent) of the rules/content for the stateful advice systems, and the remaining (e.g., about 5 percent) rules/content for the stateful advice systems can be generated by a human. Thus, stateful advice systems according to the present disclosure can be scaled at a much faster pace compared to conventional stateful advice systems.

In order for the generative AI model to generate rules/content for a stateful advice system, a user must provide a framework for the generative AI model. In some embodiments, the framework for the generative AI model can be provided by the user providing one or more configurations for a given domain (e.g., tax preparation, business planning, retirement planning, etc.) in which the stateful advice system may be used to provide stateful advice. As an example, the one or more configurations can include one or more prompts that guide the generative AI model in delivering consistent, stateful advice for a plurality of different strategies within the domain. Furthermore, in some embodiments, the prompt(s) can be applicable to each of plurality of different strategies that can be implemented within the domain. In this manner, the user does not need to provide separate prompt(s) for each of the plurality of different strategies.

In some embodiments, the configuration of the domain can include one or more “persona” prompts to identify an individual receiving the stateful advice generated by the generative AI model. For instance, if the stateful advice relates to preparing a financial document, such as a tax return, the persona prompt can indicate whether the individual receiving the stateful advice regarding preparing the financial document is an advisor (e.g., internal tax advisor or external tax advisor) or a taxpayer. It should be understood that “internal advisor” can refer to an individual that is employed by the entity implementing the stateful advice system, whereas “external advisor” can refer to an individual that is not employed by the entity implementing the stateful advice system.

In some embodiments, the generative AI model can provide the stateful advice differently depending on the persona prompt. For instance, in some embodiments, the generative AI model can, when the persona prompt indicates the individual receiving the stateful advice is an internal advisor, automatically update a domain model (e.g., tax form, business plan, retirement plan) to determine and/or reflect one or more of the plurality of different strategies that are applicable. Alternatively, or additionally, the generative AI model can, when the persona prompt indicates the individual receiving the stateful advice is an external advisor, generate computer executable code or pseudo-code for one or more of the plurality of different strategies that are applicable. In this manner, the external advisor can determine whether to execute the code or pseudo-code to implement the one or more strategies that are applicable.

Stateful advice systems according to the present disclosure provide numerous technical effects and benefits. For instance, stateful advice systems having a generative AI model that generates a majority (e.g., about 95 percent) of the rules/content can, as discussed above, be scaled more quickly compared to conventional stateful advice systems. This can be especially beneficial in complex stateful advice systems that are used, for example, to provide advice on tax strategies, business planning, or retirement planning. Furthermore, stateful advice systems described herein may produce more accurate and applicable results than existing stateful advice systems (e.g., based on only rules), such as due to the dynamic and intelligent nature of generative AI models, which are trained through an iterative learning process to provide contextually-appropriate information. By dynamically determining results that are more relevant and applicable than those produced by conventional stateful advice systems, embodiments of the present disclosure avoid unnecessary utilization of computing resources that would otherwise be utilized to process and provide results that are inaccurate or irrelevant in a particular context. Additionally, techniques described herein improve information security by, in some embodiments, utilizing a generative AI model to generate code that can be executed in a private environment to analyze sensitive data, rather than providing the sensitive data directly to the generative AI model.

Another technical effect and benefit provided by stateful advice systems of the present disclosure is that the rules/content generated by the generative AI model for one user (e.g., advisor) can be reused by other advisors for the same purpose. For instance, in some embodiments, an advisor may use the stateful advice system, specifically the generative AI model thereof, to generate rules/content for a new strategy that can then be reused by other advisors without needing the generative AI model to regenerate the rules/content for that strategy for each of the other advisors. In alternative embodiments, the generative AI model can be configured to regenerate the rules/content for the strategy until the rules/content thereof have been approved by a threshold number (e.g., 2 or more) advisors. Once the rules/content for a given strategy have been approved the threshold number of times, the rules/content for that strategy no longer need to be generated by the generative AI model each time the strategy is recommended.

### Example Stateful Advice System

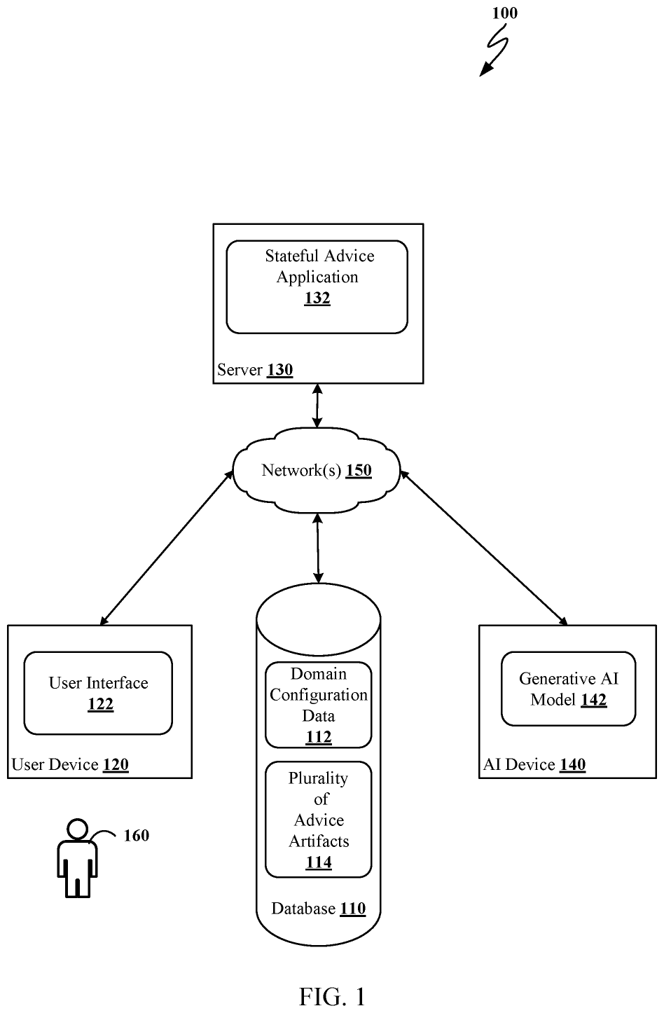

FIG. 1 illustrates components of a stateful advice system 100 configured to provide stateful advice within a given domain (e.g., tax preparation, business planning, retirement planning) according to some embodiments of the present disclosure.

As shown, the stateful advice system 100 can include a database 110, a user device 120, a server 130, and an AI device 140 connected over one or more networks 150 over which data can be transmitted. Examples of the network(s) 150 can include, without limitation, a wide area network (WAN), a local area network (LAN), and/or a cellular network.

The stateful advice system 100 can include domain configuration data 112 that defines the overall intent of the stateful advice system 100 within the domain (e.g., tax preparation, business planning, retirement planning). In some embodiments, the domain configuration data 112 can include one or more natural language prompts entered manually by a user 160. For instance, in some embodiments, the user 160 can provide the natural language prompt(s) via a user interface 122 that is implemented on the user device 120. In this manner, the natural language prompt(s) can be communicated over the network(s) 150 to a stateful advice application 132 that is implemented on the server 130.

It should be understood that, in some embodiments, the user 160 entering the one or more natural language prompts can be one or more individuals configuring the stateful advice system 100 for use by end-users (e.g., internal tax advisor, external tax advisor, or taxpayer). Stated another way, the user 160 entering the one or more natural language prompts can be someone other than the end-user of the stateful advice system 100.

The stateful advice system 100 can include a plurality of advice artifacts 114. Each of the plurality of advice artifacts 114 can be directed to a different type of advice (e.g., strategy) within the domain. For instance, the domain configuration data 112 can indicate the intent of the stateful advice system 100 is to determine applicability of a plurality of different strategies (e.g., tax-saving strategies) to a given domain model (e.g., tax return) for an end-user.

The stateful advice application 132 can be configured to provide the domain configuration data 112 to the AI device 140. The stateful advice application 132 can also be configured to provide data from the user 160 that is indicative of one or more attributes (e.g., title of new advice, description of new advice, or both) of new advice (e.g., strategy) for which an advice artifact needs to be created. For example, the data indicative of the attribute(s) of the new advice can be provided to the AI device 140 via the stateful advice application 132. More particularly, the user 160 can interact with the user interface 122 to provide the attribute(s) of the new advice to the stateful advice application 132 via the network(s) 150.

As an example, if the new advice relates to a new tax strategy, the attribute(s) can include at least a title of the new tax-savings strategy. Furthermore, in some embodiments, the attributes can include a brief description regarding how applicability of the new tax strategy to a particular tax return can be determined.

The AI device 140 can include a generative AI model 142. The generative AI model 142 can include a machine learning model. For instance, in some embodiments, the machine learning model can include a large language model (LLM). It should be understood, however, that the generative AI model 142 can include any suitable type of machine learning model.

In some embodiments, the generative AI model 142 can be a neural network. Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. In some cases, a neural network can include one or more aggregation layers, such as a softmax layer.

In some embodiments, training of the generative AI model 142 involves a supervised learning process that involves providing training inputs (e.g., domain configuration data 112 and one or more attributes for new strategies) to the machine learning model. The machine learning model can process the training inputs and determines outputs (e.g., stateful advice) based on the training inputs. The outputs are compared to known labels associated with the training inputs (e.g., labels manually applied to training data by experts or otherwise known to be associated with the training inputs, such as based on historical associations) to determine the accuracy of the model, and parameters of the model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for the model, such as based on validation data and test data, as is known in the art.

In some embodiments, the generative AI model 142 has been pre-trained, such as based on a large set of training data. The generative AI model 142 may also be re-trained on an ongoing basis, such as based on user feedback with respect to outputs produced by the model, thus providing a feedback loop by which generative AI model 142 is iteratively improved.

The generative AI model 142 can be configured to process the domain configuration data 112 as well as the data indicative of the attribute(s) of the new advice to generate an advice artifact for the new advice. The advice artifact for the new advice can include one or more natural language prompts that are generated by the generative AI model 142 and can be subsequently provided to the generative AI model 142 when an end-user provides a domain model (e.g., tax return) for which stateful advice is needed.

Although FIG. 1 depicts the database 110 and AI device 140 as being separate from the server 130, it should be understood that the scope of the present disclosure is intended to cover embodiments in which functionality of at least one of the database 110 or the AI device 140 is implemented by the server 130. For instance, in some embodiments, the domain configuration data 112 and the plurality of advice artifacts 114 can be stored on the server 130. Alternatively, or additionally, the generative AI model 142 can, in some embodiments, be implemented on the server 130. Details of the architecture of the stateful advice system 100 at both advice design time and advice run time will now be discussed in more detail.

### Example Advice Design Time Architecture for a Stateful Advice System

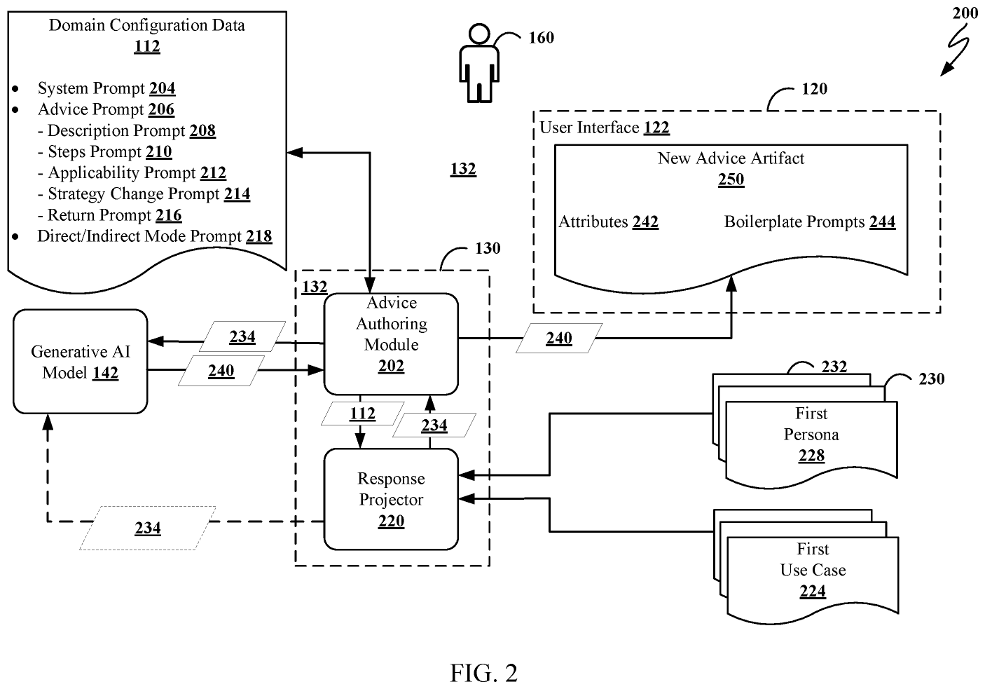

FIG. 2 illustrates an advice design time architecture 200 for a stateful advice system according to some embodiments of the present disclosure. For simplicity, the advice design time architecture 200 will be discussed in conjunction with the stateful advice system 100 of FIG. 1. It should be understood, however, that the advice design time architecture 200 is not intended to be limited to use with the stateful advice system 100 of FIG. 1 and therefore the scope of the present disclosure is intended to cover use of the advice design time architecture 200 in any suitable stateful advice system that includes a generative AI model.

The stateful advice application 132 can include an advice authoring module 202. In some embodiments, the user 160 can interact with the advice authoring module 202 via the user interface 122 implemented on the user device 120. The advice authoring module 202 can be configured to execute one or more operations during advice design time. For instance, the advice authoring module 202 can provide the domain configuration data 112 as an input to a response projector 220 of the stateful advice application 132. As shown, the domain configuration data 112 can include a system prompt 204 and an advice prompt 206. In some embodiments, the system prompt 204 and the advice prompt 206 can include natural language prompts that are manually provided (e.g., via the user interface 122) by the user 160. Examples of each of these natural language prompts will now be provided in the context of the user 160 authoring advice related to a new tax strategy that can be applied to tax returns where applicable.

The system prompt 204 can provide context for how the user 160 intends to use the generative AI model 142. For the above-mentioned example of using the generative AI model 142 to author advice related to a new tax strategy, the system prompt 204 can, for example, read as follows: “I am a tax advisor responsible for analyzing a taxpayer's tax return and making recommendations that might reduce the taxes paid by the taxpayer. You are my assistant helping me create taxpayer facing descriptions of tax strategies.”

In some embodiments, the advice prompt 206 can include a series of prompts. As an example, the series of prompts associated with using the generative AI model 142 to author advice regarding a new tax strategy can include, without limitation, a description prompt 208, a steps prompt 210, an applicability prompt 212, a strategy change prompt 214, and a return modification prompt 216. Each of these prompts will now be discussed individually.

The description prompt 208 can request that the generative AI model 142 generate a description of the new tax savings strategy. For example, the description prompt 208 can read as follows: “Please provide a description of the new tax strategy in 1000 characters or less but use as close to 1000 as you can to be thorough. You do not need to provide disclaimers because I am the tax professional and I am responsible for mediating your advice.”

The steps prompt 210 can request that the generative AI model 142 determine what steps must be taken by a taxpayer in order to take advantage of the new tax strategy. For example, the steps prompt 210 can read as follows: “What are the top 3 next steps for my taxpayer to take advantage of the new tax strategy? Summarize each step in 200 characters or less. Only include the steps and no other descriptions, summary information or disclaimers.”

The applicability prompt 212 can request that the generative AI model 142 explain how to determine whether the new tax strategy is applicable to a given tax return. For example, the applicability prompt 212 can read as follows: “Given the following tax return, can you describe how to determine if the new tax strategy is applicable. If you are asked to generate code, include conditional expressions without function definitions.”

The strategy change prompt 214 can request that the generative AI model 142 explain how to calculate the impact the new tax strategy has on a given tax return. For example, the strategy change prompt 214 can read as follows: “Given the following tax return and the below formula, can you describe how to calculate the strategy change amount for the new tax strategy. The strategy_change variable should represent the difference when the tax return is modified to reflect that change.”

$${tax}_{s a v i n g s} = {strategy}_{-} change * {total}_{-} t a {x}_{-} r a t e \qquad ( Equation 1 )$$

The return modification prompt 216 can request that the generative AI model 142 explain how a given tax return needs to be modified to take advantage of the new tax strategy. For example, the return modification prompt 216 can read as follows: “Given the following tax return, can you describe how to modify the tax return to take advantage of the new tax strategy if it were applicable.”

In some embodiments, the domain configuration data 112 can include a direct/indirect mode prompt 218 to indicate whether the stateful advice system 100 is to be operated in a first mode (e.g., direct mode) or a second mode (e.g., indirect mode) for the given domain (e.g., tax preparation, business planning, retirement planning). As will be discussed later on in more detail, the stateful advice system 100 can directly access (e.g., read/write to) a domain model (e.g., tax return, business plan, etc.) when operating in the first mode (e.g., direct mode). In this manner, the stateful advice system 100 can directly process and/or update the domain model to reflect advice enumerated in one or more advice artifacts 114 (FIG. 1) that the stateful advice system 100 determines are applicable to the domain model.

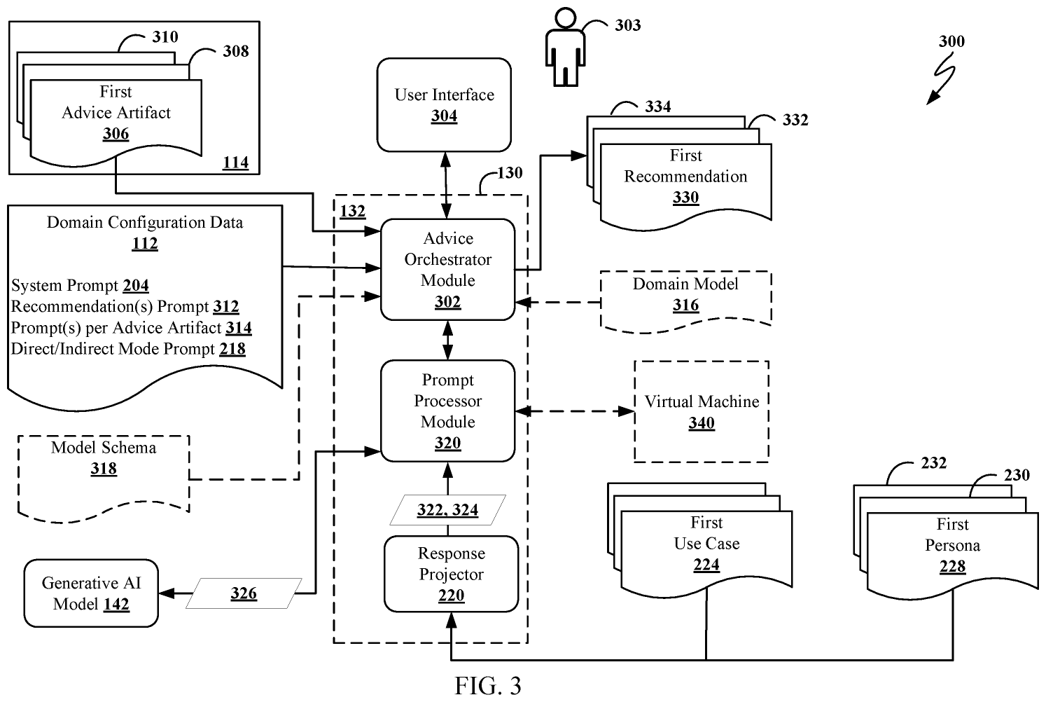

Conversely, the stateful advice system 100 cannot directly access the domain model when operating in the second mode (e.g., indirect mode). Instead, in the second mode, the stateful advice system 100 must process and/or update the domain model indirectly through another device, such as a virtual machine configured to implement computer-executable code that is needed to process and/or update the domain model. For instance, as will be discussed later on in more detail with reference to FIG. 3, the stateful advice system 100 can, when operating in the second mode for a given domain, obtain a schema for the domain model that defines variables included in the domain model and allows the stateful advice system 100 to generate computer-executable code with the requisite variables of the domain model that are needed to implement a given strategy. In this manner, another device (e.g., virtual machine) that receives the computer-executable code from the stateful advice system 100 can execute the computer-executable code to access the domain model and update the domain model to reflect the applicable strategies.

It should be appreciated that privacy concerns associated with a domain (e.g., tax preparation, business planning, etc.) in which the stateful advice system 100 provides stateful advice can impact the mode (e.g., direct or indirect) in which the stateful advice system 100 operates. For example, privacy concerns associated with sensitive information included in tax returns can, in some instances, require the stateful advice system 100 operate in the second mode (e.g., indirect mode) because operating the stateful advice system 100 in the first mode (e.g., direct mode) could expose a security threat with respect to the sensitive information.

The response projector 220 can be configured to perform one or more operations during advice design time. For instance, the response projector 220 can be configured to determine that the generative AI model 142 is being used for one of a plurality of use cases based, at least in part, on the domain configuration data 112. In the above example, the response projector 220 can be configured to determine based, at least in part, on the applicability prompt 212 included in the domain configuration data 112 that the use case for the generative AI model 142 corresponds to a first use case 224 associated with determining applicability of the new tax strategy to a given tax return.

The response projector 220 can be further configured to determine a persona of the end-user based, at least in part, on the domain configuration data 112. For instance, in some embodiments, the response projector 220 can determine the persona of the end-user based, at least in part, on the system prompt 204 input by the user 160 and included in the domain configuration data 112. In the above example, the response projector 220 can determine that the persona of the end-user is an advisor (e.g., internal or external) and not a taxpayer. In some embodiments, the system prompt 204 can further include information indicating a type (e.g., internal or external) of the advisor.

It should be understood that the term “internal advisor” refers to an individual that is associated with (e.g., an employee of) the entity responsible for the stateful advice system 100 (FIG. 1). Conversely, the term “external advisor” refers to a person that is not associated with (e.g., not an employee of) the entity responsible for the stateful advice system 100. Finally, the term “taxpayer” generally refers to an individual that is preparing their own tax return instead of the tax return of another individual and therefore cannot be considered an advisor (e.g., internal or external).

The response projector 220 can be configured to contextualize responses from the generative AI model 142 based, at least in part, on the persona of the end-user, the use case of the generative AI model 142 as indicated by the advice prompts 206, or both. For instance, the data indicative of the selected use case (e.g., first use case 224) can be concatenated to the end (e.g., direct/indirect mode prompt 218) of the domain configuration data 112 to generate an intermediate concatenated prompt. Furthermore, the persona (e.g., a first persona 228 corresponding to an internal advisor, a second persona 230 corresponding to an external advisor, or a third persona 232 corresponding to a taxpayer) of the end-user can be concatenated to the end of the intermediate concatenated prompt to generate a concatenated prompt 234. The concatenated prompt 234 can be provided as an input to the generative AI model 142. In some embodiments, the response projector 220 can provide the concatenated prompt 234 directly (e.g., denoted by dashed line) to the generative AI model 142. In alternative embodiments, the response projector can provide the concatenated prompt 234 to the generative AI model via the advice authoring module 202.

The generative AI model 142 can be configured to automatically author content 240 based, at least in part, on the concatenated prompt 234. The content 240 automatically authored by the generative AI model 142 can include one or more attributes 242 (e.g., static content) of the new tax strategy. For instance, the one or more attributes for the new tax strategy can include a description of the new tax strategy. It should be appreciated that the description of the new tax strategy can correspond to content the generative AI model 142 automatically authors as a response to the description prompt 208. Additionally, the one or more attributes of the new tax strategy can include one or more steps (e.g., action items) a taxpayer must take in order to take advantage of the new tax strategy. It should be appreciated that the one or more steps can correspond to content the generative AI model 142 automatically authors as a response to the steps prompt 210.

The content 240 automatically authored by the generative AI model 142 can also include a plurality of boilerplate prompts 244 (e.g., applicability, constraints, mutations needed to domain model to implement advice, explanation of benefits of adopting the advice) for the new tax strategy. As will be discussed later on with reference to FIG. 3, the boilerplate prompts 244 can be provided to the generative AI model 142 at run-time to determine applicability of the new tax strategy to a given tax return.

In some embodiments, a boilerplate prompt previously authored by the generative AI model 142 can be provided as an input to the generative AI model 142 during advice design time to improve the accuracy of one or more boilerplate prompts that are subsequently authored by the generative AI model 142. For instance, a first boilerplate prompt that the generative AI model 142 authors in response to the description prompt 208 included in the domain configuration data 112 can be provided as an input to the generative AI model 142 to improve the accuracy of a second boilerplate prompt that the generative AI model 142 authors in response to the applicability prompt 212 that is included in the domain configuration data 112. In this manner, the accuracy of boilerplate prompts 244 authored by the generative AI model 142 can be improved compared to embodiments in which the generative AI model 142 authors all of the boilerplate prompts 244 based on a single attribute (e.g., a title) of the new strategy.

In some embodiments, the content 240 automatically authored by the generative AI model 142 can be formatted based, at least in part, on the selected use case (e.g., first use case 224), selected persona of the end-user, or both. For instance, the level of detail included in the attribute(s) 242 (e.g., description of new tax strategy) can vary depending on the selected use case for the generative AI model 142 and the selected persona of the end-user. As an example, if the selected persona indicates the end-user is an internal advisor or external advisor, the attribute(s) 242 (e.g., description of the new tax strategy) can include a greater level of detail than if the selected persona indicated the end-user is a taxpayer.

Alternatively, or additionally, the boilerplate prompts 244 included in the content 240 authored by the generative AI model 142 can be formatted based, at least in part, on the persona of the end-user. For example, if the user 160 is an internal advisor, the boilerplate prompts can be presented in a first format that includes computer-code (e.g., JavaScript Objection Notation script). Conversely, if the end-user is an external advisor, the boilerplate prompts can be presented in a second format (e.g., combination of natural language and computer-code) that is different from the first format. Finally, if the user is a taxpayer, the boilerplate prompts can be presented in a third format (e.g., natural language prompts only) that is different from the first format and the second format.

In some embodiments, the content 240 automatically authored by the generative AI model 142 can be presented to the user 160 via the user interface 122 implemented on the user device 120. In this manner, the user 160 can review the content 240 and modify the content 240 as needed. For example, the user 160 can modify the natural language prompts that, in some embodiments, are included with the boilerplate prompts 244. In such embodiments, the revised natural language prompts can be provided to the generative AI model 142 and the generative AI model 142 can automatically revise computer-generated code accompanying the natural language prompt so that the revised computer-generated code reflects the modifications to the natural language prompts by the user 160. Furthermore, the generative AI model 142 can learn from the modification(s) to the natural language prompts and can therefore avoid generating the same or similar natural language prompts for other advice (e.g., other tax strategies) for which the generative AI model 142 is requested to author content.

Once the user 160 finishes editing the content 240 automatically authored by the generative AI model 142, a new advice artifact 250 for the new advice (e.g., tax strategy) can be created. As shown, the new advice artifact 250 can include the attribute(s) 242 and boilerplate prompts 244 for the new advice. It should be understood that the database 110 discussed above with reference to FIG. 1 can be updated so that the new advice artifact 250 is included in the plurality of advice artifacts 114.

### Example Advice Design Time Architecture for a Stateful Advice System

FIG. 3 illustrates an advice runtime architecture 300 for a stateful advice system according to some embodiments of the present disclosure. For simplicity, the advice runtime architecture 300 will be discussed in conjunction with the stateful advice system 100 of FIG. 1. It should be understood, however, that the advice runtime architecture 300 is not intended to be limited to use with the stateful advice system 100 of FIG. 1 and therefore the scope of the present disclosure is intended to cover use of the advice runtime architecture 300 in any suitable stateful advice system that includes a generative AI model.

The stateful advice application 132 can include an advice orchestrator module 302. In some embodiments, a user 303 can interact with the advice orchestrator module 302 via a user interface 304. In some embodiments, the user interface 304 can include the user interface 122 of the user device 120 discussed above with reference to FIG. 1.

The advice orchestrator module 302 can be configured to perform one or more operations during advice runtime. For instance, the advice orchestrator module 302 can be configured to enumerate the content (e.g., attributes, boilerplate prompts) for each of a plurality of advice artifacts previously authored by the generative AI model 142 at advice design time and included in a library of advice artifacts, such as the plurality of advice artifacts 114 discussed above with reference to FIG. 1. Thus, as illustrated in FIG. 3, the advice orchestrator module 302 can be configured to enumerate the content for a first advice artifact 306 included in the library of advice artifacts 114, the content for a second advice artifact 308 included in the library of advice artifacts 114, the content for a third advice artifact 310 included in the library of advice artifacts 114, and so on until the advice orchestrator module 302 has enumerated the previously authored content for each of the plurality of advice artifacts 114.

The advice orchestrator module 302 can be configured to obtain the domain configuration data 112. As shown, the domain configuration data 112 can include the system prompt 204 and direct/indirect mode prompt 218 discussed above with reference to the advice design time architecture 200 illustrated in FIG. 2.

The domain configuration data 112 can also include one or more recommendation prompts 312. For instance, in some embodiments, the domain configuration data 112 can include a recommendation prompt that is applicable to each of the plurality of advice artifacts (e.g., first advice artifact 306, second advice artifact 308, third advice artifacts 310). Thus, the domain configuration data 112 can include a first recommendation prompt for the first advice artifact 306, a second recommendation prompt for the second advice artifact 308, a third recommendation prompt for the third advice artifact 310, and so on for each of the plurality of advice artifacts 114.

In some embodiments, the user 303 may not want the stateful advice system 100 to provide a recommendation for each of the plurality of advice artifacts. In such embodiments, the user 303 can provide input to the advice orchestrator module 302 via the user interface 304 to remove one or more of the recommendation prompts 312.

The domain configuration data 112 can also include boilerplate prompts 314 for each of the plurality of advice artifacts. For instance, in some embodiments, the first advice artifact 306 of the plurality of advice artifacts can be the most-recent advice artifact (e.g., advice artifact 250 of FIG. 2) created by the stateful advice system 100. Thus, in such embodiments, the boilerplate prompts 314 for the first advice artifact 306 can include the boilerplate prompts 244 (FIG. 2) authored by the generative AI model 142 for a given strategy.

The advice orchestrator module 302 can obtain either a domain model 316 (e.g., tax return) or a model schema 318 of the domain model 316 depending on the direct/indirect mode prompt 218 that is included in the domain configuration data 112. For instance, if the direct/indirect mode prompt 218 indicates that the stateful advice system 100 must operate in the direct mode at advice runtime, then the advice orchestrator module 302 can obtain the domain model 316. If, however, the direct/indirect mode prompt 218 indicates that the stateful advice system 100 must operate in the indirect mode at advice runtime, the advice orchestrator module 302 cannot obtain the domain model 316 and instead must obtain the model schema 318 for the domain model 316. The model schema 318 may, for example, be a blueprint of the domain model 316. For instance, the model schema 318 may identify variables and/or relationships among variables in the domain model 316 without including the data with which those variables are populated in the domain model 316. Thus, while the domain model 316 may include sensitive data, the model schema 318 would not include such sensitive data.

The stateful advice application 132 can include a prompt processor module 320. The prompt processor module 320 can be configured to obtain the domain configuration data 112 from the advice orchestrator module 302. Furthermore, the prompt processor module 320 can, in embodiments in which the domain configuration data 112 (that is, the direct/indirect mode prompt 218 prompt thereof) indicates the stateful advice system 100 is to be operated in the indirect mode, obtain the model schema 318 for the domain model 316.

The prompt processor module 320 can be configured to obtain data 322 indicative of the selected use case for the generative AI model 142 and data 324 indicative of the selected persona of the user 303 from the response projector 220. For instance, the data obtained from the response projector 220 can include data 322 indicative of the selected use case and persona based, at least in part, on the domain configuration data 112. More specifically, the response projector 220 can determine the generative AI model 142 will be used to provide recommendations based, at least in part, on the recommendations prompt 312 included in the domain configuration data 112. Additionally, the response projector 220 can determine the persona of the user 303 based, at least in part, on the system prompt 204 included in the domain configuration data 112.

The prompt processor module 320 can be configured to concatenate the domain configuration data 112. For instance, the prompt processor module 320 can be configured to concatenate the domain configuration data 112 to generate a first intermediate concatenated prompt that includes the system prompt 204, the recommendation prompt(s) 312, the boilerplate prompts 314 for each of the given advice artifacts identified in the recommendation prompts 312, and the direct/indirect mode prompt 218. The prompt processor module 320 can be further configured to concatenate the domain model 316 or the model schema 318 to the end of the first intermediate concatenated prompt to generate a second intermediate concatenated prompt. The prompt processor module 320 can be even further configured to concatenate data 322 and data 324 from the response project 220 to generate a concatenated prompt 326.

The generative AI model 142 can be configured to receive the concatenated prompt 326. If the stateful advice system 100 is operating in the direct mode, then the generative AI model 142 can receive the domain model 316 and can return a response which, in this case, would be a recommendation for one or more advice artifacts that the generative AI model 142 determines are applicable based, at least in part, on the boilerplate prompts 244 (FIG. 2) that are unique to the one or more advice artifacts.

In embodiments in which the domain model 316 is a tax return and the advice artifacts included in the library of advice artifacts 114 are directed to different tax strategies, the generative AI model 142 can generate a first recommendation 330 to apply to the domain model 316 a first tax strategy enumerated in the first advice artifact 306. Furthermore, in some embodiments, the generative AI model 142 can recommend applying additional tax strategies to the domain model 316. More specifically, the generative AI model 142 can generate a second recommendation 332 associated with a second tax strategy enumerated in the second advice artifact 308 and, in some embodiments, can recommend a third tax strategy enumerated in the third advice artifact 310.

In some embodiments in which the direct/indirect mode prompt 218 included in the domain configuration data 112 indicates that the stateful advice system 100 is to operate in the indirect mode, the prompt processor module 320 can, in some embodiments, be configured to generate computer executable code to determine applicability of the plurality of advice artifacts. In alternative embodiments, the prompt processor module 320 can, instead of generating the computer executable code, provide computer executable code that was generated for each of the advice artifacts during advice design time. Regardless of whether the prompt processor module 320 generates computer executable code or reuses computer executable code generated by the generative AI model 142, the prompt processor module 320 can provide the computer executable code (in both cases) to a virtual machine 340 that is configured to execute the computer executable code to determine applicability for each of the advice artifacts. For example, the computer executable code executed in the virtual machine 340 may evaluate the domain model 316 in order to determine a recommendation for one or more advice artifacts that are applicable to the domain model 316. Furthermore, the virtual machine 340 can be configured to provide recommendations for each of the advice artifacts that the virtual machine 340 determines are applicable.

Sequence Diagram for Authoring Advice using a Stateful Advice System

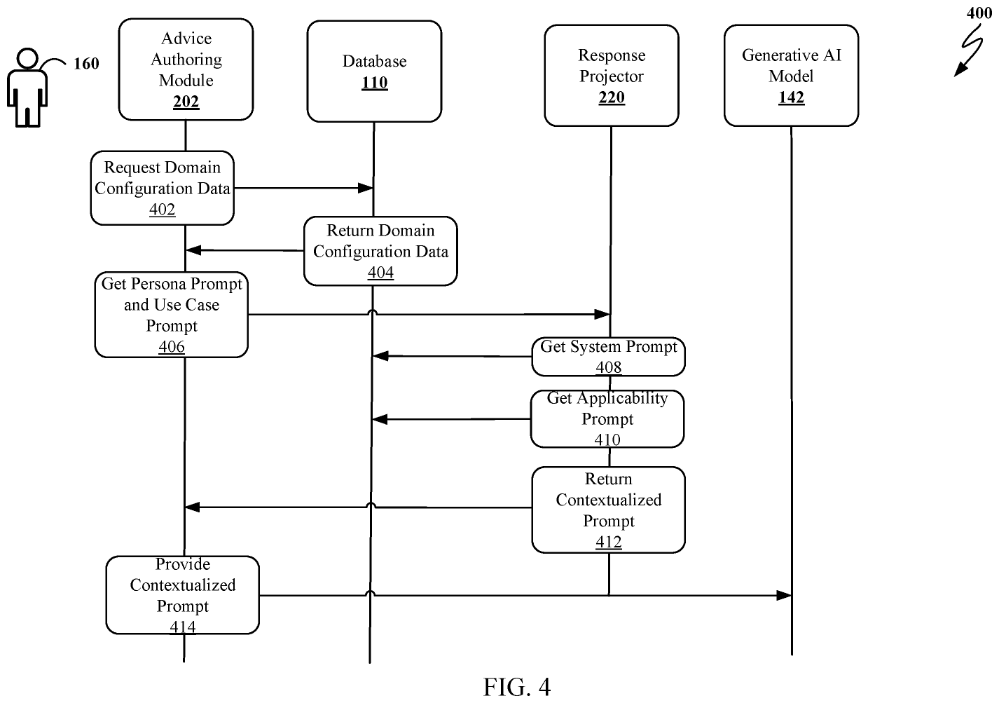

FIG. 4 illustrates a sequence diagram 400 for authoring advice using a stateful advice system according to some embodiments of the present disclosure. For simplicity, the sequence diagram 400 will be discussed in conjunction with the stateful advice system 100 of FIG. 1.

In this example, the advice authoring module 202 can receive data indicative of new advice (e.g., strategy) for which content needs to be automatically authored using the generative AI model 142. For example, the user 160 can interact with a user interface (such as the user interface 122 of FIG. 1) to provide a title for the new advice. As an example, the title for the new advice could be “Passive Activity with Material Participation.”

At (402), the advice authoring module 202 can request domain configuration data for the domain (e.g., tax preparation) in which the advice is applicable.

At (404), the database 110 can return the domain configuration data 112 for the domain. The domain configuration data 112 can, as discussed above, include the system prompt 204, advice prompt 206 (e.g., a series of advice prompts) and the direct/indirect mode prompt 218 discussed above with reference to FIG. 2.

At (406), the advice authoring module 202 can prompt the response projector 220 to determine the persona of the user 160 and the use case prompt for the generative AI model 142.

At (408), the response projector 220 can request the system prompt (such as the system prompt 204 in FIG. 2) that is configured to obtain the persona (e.g., internal advisor, external advisor, taxpayer) of the user 160.

At (410), the response projector 220 can request the applicability prompt (such as the applicability prompt 212 in FIG. 2) that is configured to determine the use case for the generative AI model 142.

At (412), the response projector 220 can generate a prompt for the generative AI model 142 that is contextualized for the persona of the user 160 and the use case for the generative AI model 142. It should be appreciated that the contextualized prompt can be the concatenated prompt 234 discussed above with reference to FIG. 2. As shown, the prompt can be provided to the advice authoring module 202.

At (414), the advice authoring module 202 can provide the prompt generated at (412) to the generative AI model 142 to prompt the generative AI model 142 to automatically author content (e.g. attributes and boilerplate prompts) to be included in a new advice artifact for the new advice.

### Method for Operating a Stateful Advice System

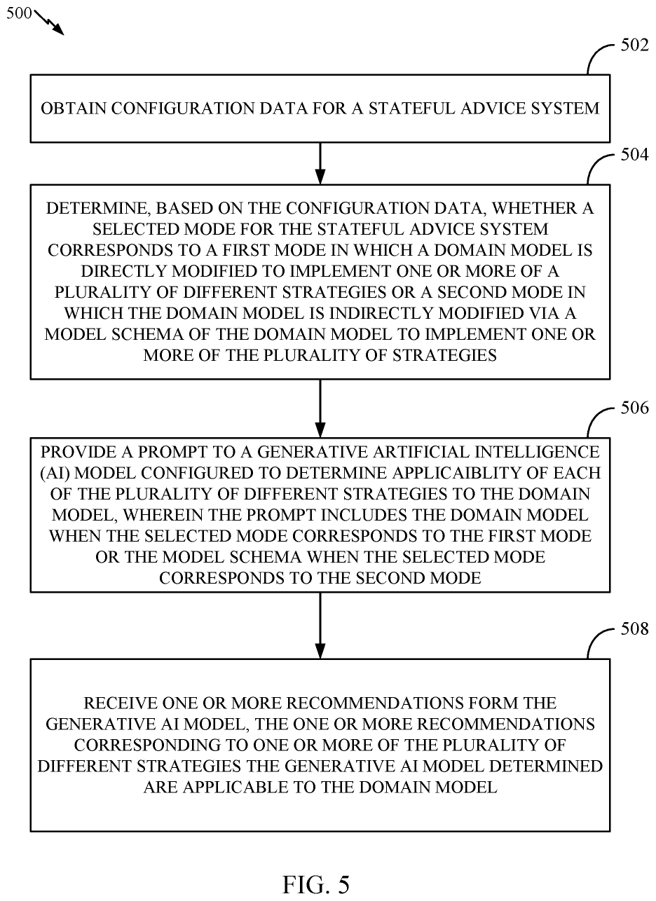

FIG. 5 is a flow diagram of an example method 500 for operating a stateful advice system, such as the stateful advice system 100 of FIG. 1. The method 500 may be performed by instructions executing on a processor of a server (such as the server 130 of FIG. 1) and include the function of a stateful advice application (such as the stateful advice application 132 of FIG. 1).

At (502), the method 500 includes obtaining configuration data for the stateful advice system. In some embodiments, the configuration data can be manually entered by a user interacting with a user interface implemented on a user device (such as the user device 120 of FIG. 1).

At (504), the method 500 includes determining, based on the configuration data obtained at (502), whether a selected mode for the stateful advice system corresponds to a first mode (e.g., direct mode) in which a domain model is directly modified to implement one or more of a plurality of different strategies or a second mode (e.g., indirect mode) in which the domain model is indirectly modified via a model schema of the domain model to implement one or more of the plurality of strategies.

At (506), the method 500 includes providing a prompt to a generative artificial intelligence model configured to determine applicability of each of the plurality of different strategies to the domain model. The prompt may include the domain model when the selected mode of the stateful advice system corresponds to the first mode (e.g., direct mode). Conversely, the prompt may include the model schema when the selected mode of the stateful advice system corresponds to the second mode (e.g., indirect mode).

At (508), the method 500 includes receiving one or more recommendations from the generative artificial intelligence model. The one or more recommendations may correspond to one or more of the plurality of different strategies that the generative artificial intelligence model determined are applicable.

In some embodiments, the method 500 may further include updating the domain model to implement the one or more recommendations. If the selected mode of the stateful advice system corresponds to the first mode, updating the domain model may include directly accessing the domain model to modify one or more variables included therein to implement the one or more recommendations. If the selected mode of the stateful advice system corresponds to the second mode, updating the domain model may include indirectly modifying the domain model via the model schema. For example, in some embodiments, indirectly modifying the domain model may include determining one or more variables of the plurality of variables included in the domain model need to be modified to implement the one or more recommendations. In addition, indirectly modifying the domain model may include generating computer-executable code based on the model schema and the one or more variables that need to be modified in the domain model. In some embodiments, the computer-executable code may be provided to a remote device (e.g., virtual machine 340 illustrated in FIG. 3) that is configured to access the domain model. In this manner, the remote device may execute the computer-executable code to update the variables of the domain model that need to be modified to implement the one or more recommendations.

### Example Computing Systems

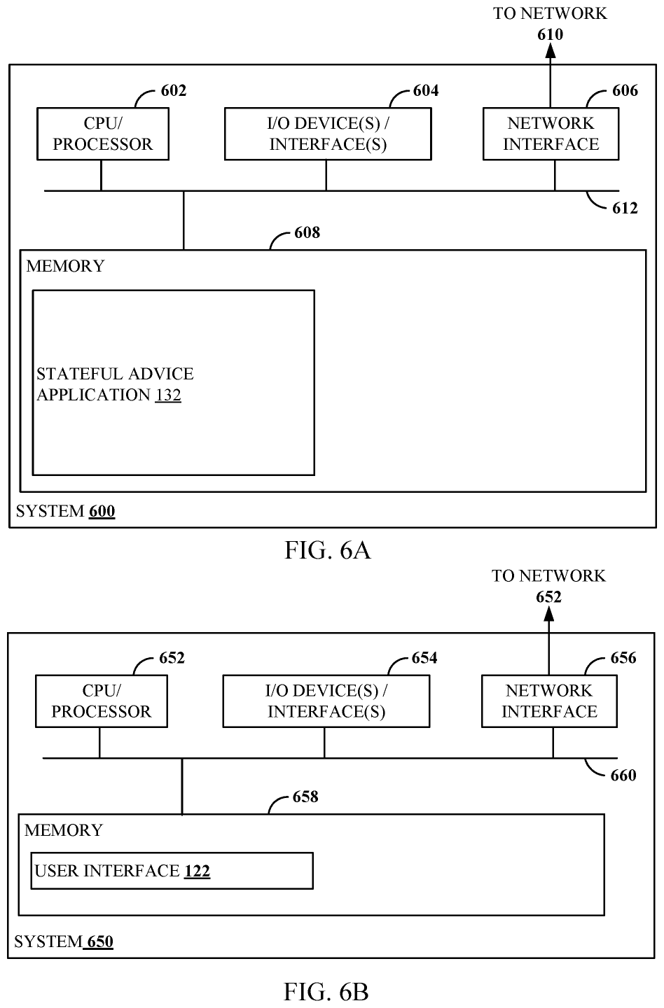

FIG. 6A illustrates an example computing system 600 with which embodiments of a stateful advice system (e.g., stateful advice system 100 of FIG. 1) may be implemented. For example, the computing system 600 may be representative of the server 130 of FIG. 1.

The computing system 600 includes a central processing unit (CPU) 602, one or more I/O device interfaces 604 that may allow for the connection of various I/O devices 604 (e.g., keyboards, displays, mouse devices, pen input, etc.) to the computing system 600, a network interface 606, a memory 608, and an interconnect 612. It is contemplated that one or more components of the computing system 600 may be located remotely and accessed via a network 610 (e.g., which may be the network 150 of FIG. 1). It is further contemplated that one or more components of the computing system 600 may include physical components or virtualized components.

The CPU 602 may retrieve and execute programming instructions stored in the memory 608. Similarly, the CPU 602 may retrieve and store application data residing in the memory 608. The interconnect 612 transmits programming instructions and application data, among the CPU 602, the I/O device interface 604, the network interface 606, the memory 608. The CPU 602 is included to be representative of a single CPU, multiple CPUs, a single CPU having multiple processing cores, and other arrangements.

Additionally, the memory 608 is included to be representative of a random access memory or the like. In some embodiments, the memory 608 may include a disk drive, solid state drive, or a collection of storage devices distributed across multiple storage systems. Although shown as a single unit, the memory 608 may be a combination of fixed and/or removable storage devices, such as fixed disc drives, removable memory cards or optical storage, network attached storage (NAS), or a storage area-network (SAN).

As shown, the memory 608 includes stateful advice application 132, which may be representative of the stateful advice application 123 of FIG. 1.

FIG. 6B illustrates an example computing system 650 with which embodiments of a stateful advice system (e.g., stateful advice system 100 of FIG. 1) may be implemented. For example, the computing system 650 may be representative of the user device 120 of FIG. 1.

The computing system 650 includes a central processing unit (CPU) 652, one or more I/O device interfaces 654 that may allow for the connection of various I/O devices 654 (e.g., keyboards, displays, mouse devices, pen input, etc.) to the computing system 650, a network interface 656, a memory 658, and an interconnect 660. It is contemplated that one or more components of the computing system 650 may be located remotely and accessed via a network 652 (e.g., which may be the network 150 of FIG. 1). It is further contemplated that one or more components of the computing system 650 may include physical components or virtualized components.

The CPU 652 may retrieve and execute programming instructions stored in the memory 658. Similarly, the CPU 562 may retrieve and store application data residing in the memory 658. The interconnect 662 transmits programming instructions and application data, among the CPU 652, the I/O device interface 654, the network interface 656, the memory 658. The CPU 652 is included to be representative of a single CPU, multiple CPUs, a single CPU having multiple processing cores, and other arrangements.

Additionally, the memory 658 is included to be representative of a random access memory or the like. In some embodiments, the memory 658 may include a disk drive, solid state drive, or a collection of storage devices distributed across multiple storage systems. Although shown as a single unit, the memory 658 may be a combination of fixed and/or removable storage devices, such as fixed disc drives, removable memory cards or optical storage, network attached storage (NAS), or a storage area-network (SAN).

As shown, memory 658 includes the user interface 122, which may be representative of the user interface 122 of FIG. 1.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for operating a stateful advice system, comprising:
obtaining configuration data for the stateful advice system;
determining, based on the configuration data, whether a selected mode for the stateful advice system corresponds to a first mode in which a domain model is directly modified to implement one or more of a plurality of different strategies or a second mode in which the domain model is indirectly modified via a model schema of the domain model to implement one or more of the plurality of different strategies;
providing a prompt to a generative artificial intelligence (AI) model configured to determine applicability of each of the plurality of different strategies to the domain model, wherein the prompt includes the domain model when the selected mode corresponds to the first mode or the model schema when the selected mode corresponds to the second; and
receiving one or more recommendations from the generative AI model, the one or more recommendations corresponding to one or more of the plurality of different strategies the generative AI model determined are applicable.

2. The method of claim 1, further comprising:
updating the domain model based on the one or more recommendations and according to the selected mode of the stateful advice system.

3. The method of claim 2, wherein when the selected mode of the stateful advice system corresponds to the first mode, the updating comprises accessing the domain model to modify one or more variables of the domain model to implement the one or more recommendations.

4. The method of claim 2, wherein when the selected mode of the stateful advice system corresponds to the second mode, the updating comprises indirectly modifying the domain model via the model schema.

5. The method of claim 4, wherein:
the model schema defines a plurality of different variables included in the domain model; and
indirectly modifying the domain model via the model schema comprises:
determining one or more variables of the plurality of variables included in the domain model need to be modified to implement the one or more recommendations; and
generating computer-executable code based on the model schema and the one or more variables that need to be modified in the domain model.

6. The method of claim 5, wherein indirectly modifying the domain model via the model schema further comprises:
providing the computer-executable code to a virtual machine configured to update the domain model.

7. The method of claim 1, wherein:
the configuration data comprises a plurality of different prompts; and
providing the prompt to the generative AI model comprises:
concatenating the plurality of different prompts included in the configuration data to generate a first concatenated prompt;
concatenating the domain model to the first concatenated prompt to generate a second concatenated prompt; and
providing the second concatenated prompt to the generative AI model.

8. The method of claim 7, wherein the plurality of different prompts comprise:
a system prompt; and
an advice prompt for each of a plurality of advice artifacts, each of the plurality of advice artifacts corresponding to a respective strategy of the plurality of different strategies.

9. The method of claim 8, wherein each of the plurality of advice artifacts includes a plurality of prompts, the plurality of prompts comprising:
a first prompt including an explanation of how to determine applicability of the respective strategy to the domain model; and
a second prompt including an explanation of how to modify the domain model to the apply the respective strategy.

10. The method of claim 1, wherein the domain model comprises a financial document.

11. The method of claim 1, wherein:
the domain model includes sensitive information; and
the model schema does not include the sensitive information.

12. A stateful advice system comprising:
a memory including computer executable instructions; and
one or more processors configured to execute the computer executable instructions and cause the one or more processors to perform a method comprising:
obtaining configuration data for the stateful advice system;
determining, based on the configuration data, whether a selected mode for the stateful advice system corresponds to a first mode in which a domain model is directly modified to implement one or more of a plurality of different strategies or a second mode in which the domain model is indirectly modified via a model schema of the domain model to implement one or more of the plurality of different strategies;
providing a prompt to a generative artificial intelligence (AI) model configured to determine applicability of each of the plurality of different strategies to the domain model, wherein the prompt includes the domain model when the selected mode corresponds to the first mode or the model schema when the selected mode corresponds to the second; and
receiving one or more recommendations from the generative AI model, the one or more recommendations corresponding to one or more of the plurality of different strategies the generative AI model determined are applicable.

13. The stateful advice system of claim 12, wherein the method further comprises updating the domain model based on the one or more recommendations and according to the selected mode of the stateful advice system.

14. The stateful advice system of claim 13, wherein when the selected mode of the stateful advice system corresponds to the first mode, the updating comprises directly modifying one or more variables of the domain model.

15. The stateful advice system of claim 13, wherein when the selected mode of the stateful advice system corresponds to the second mode, the updating comprises indirectly modifying the domain model via the model schema.

16. The stateful advice system of claim 15, wherein:
the model schema defines a plurality of different variables included in the domain model; and
indirectly modifying the domain model via the model schema comprises:
determining one or more variables of the plurality of variables included in the domain model need to be modified to implement the one or more recommendations; and
generating computer-executable code based on the model schema and the one or more variables that need to be modified in the domain model.

17. The stateful advice system of claim 16, wherein indirectly modifying the domain model via the model schema further comprises:
providing the computer-executable code to a virtual machine configured to update the domain model.

18. The stateful advice system of claim 10, wherein:
the configuration data comprises a plurality of different prompts; and
providing the prompt to the generative AI model comprises:
concatenating the plurality of different prompts included in the configuration data to generate a first concatenated prompt;
concatenating the domain model to the first concatenated prompt to generate a second concatenated prompt; and
providing the second concatenated prompt to the generative AI model.

19. The stateful advice system of claim 14, wherein the plurality of different prompts comprise:
a system prompt; and
an advice prompt for each of a plurality of advice artifacts, each of the plurality of advice artifacts corresponding to a respective strategy of the plurality of different strategies.

20. A non-transitory computer readable medium comprising instructions to be executed by a stateful advice system comprising one or more processors, wherein the instructions executed in the one or processors perform a method comprising:
obtaining configuration data for the stateful advice system;
determining, based on the configuration data, whether a selected mode for the stateful advice system corresponds to a first mode in which a domain model is directly modified to implement one or more of a plurality of different strategies or a second mode in which the domain model is indirectly modified via a model schema of the domain model to implement one or more of the plurality of different strategies;
providing a prompt to a generative artificial intelligence (AI) model configured to determine applicability of each of the plurality of different strategies to the domain model, wherein the prompt includes the domain model when the selected mode corresponds to the first mode or the model schema when the selected mode corresponds to the second; and
receiving one or more recommendations from the generative AI model, the one or more recommendations corresponding to one or more of the plurality of different strategies the generative AI model determined are applicable.
